(19) United States
(12) Patent Application Publication
(10) Pub. No.: US 2010/0076826 A1
(43) Pub. Date: Mar. 25, 2010

(54) ONBOARD AUCTION OF A FIRST CLASS SEAT TICKET

(76) Inventor: Anthony Jeremiah Bayne, Lomita, CA (US)

Correspondence Address: ANTHONY JEREMIAH BAYNE, 25315 ANDREO AVENUE, LOMITA, CA, 90717, US

(21) Appl. No.: 12/248,033

(22) Filed: Oct. 8, 2008

Related U.S. Application Data
(60) Provisional application No. 61/098,751, filed on Sep. 20, 2008.

(51) Int. Cl. G06Q 30/00; G06Q 90/00

(52) U.S. Cl. 705/14.3; 705/37

(57) ABSTRACT

A system and method for making a sale of a ticket for an available first class seat, to a passenger seated in second class, when a carrier is underway to a final destination (i.e. is not scheduled to pick up additional passengers). The system may offer to sell the first class seat ticket only to members of the carrier's customer loyalty program (e.g. frequent flyer), or to any passenger seated in second class. When two or more passengers are seated in second class, the price of the ticket may be established by auction.

### RELATED APPLICATION

This application is based on and claims priority to U.S. Provisional Patent Application No. 61/098,751, filed Sep. 20, 2008, the entire disclosure of which is hereby incorporated by reference.

### BACKGROUND OF THE INVENTION

1. Field of the Invention

The present invention generally relates to selling a first class ticket to a passenger in a lower class accommodation, and more particularly to a system and method for selling a first class seat ticket to a passenger seated in a lower class accommodation, when an empty first class seat is available and no additional passenger will be boarding, so that a carrier may earn additional revenue.

2. Description of Related Technology

Many carriers, including airlines, cruise lines, and passenger trains offer passengers more than one class of travel, typically a luxury class accommodation (hereinafter collectively referred to as “first class”), and a lower class accommodation, such as business class, economy, second class, third class, etc. (hereinafter collectively referred to as “second class”). The first and second class accommodations are typically located in separate cabins of the carrier, separated by a bulkhead, car, etc.

When many empty first class seats are available on a carrier (e.g. an empty row, or an empty group of two or more first class seats) first class passengers may reseat themselves on them, to have even more room during a flight.

A carrier makes no money on unsold, empty first class seats. When a plane (or other carrier) is on a single-leg (i.e. non-stop) flight, or is underway to its final destination (i.e. no additional passenger will be boarding), no opportunity exists to make an additional ticket sale for any empty first class seat.

When a seated second class passenger gets a poor seat assignment (e.g. next to a passenger who is coughing, passenger who smells bad, etc.) for a lengthy flight (e.g. over 5 hours), with no prospect of relocating to another seat in the second class cabin, the passenger may be willing to pay additional money to escape his/her seating situation and move into a first class cabin.

Carriers are often looking for new ways to earn revenue from their current customers. Therefore a need remains to sell excess first class capacity, at the best price possible, by giving a seated second class passenger, who wants to move, an opportunity to buy a ticket for an available first class seat, when a carrier is underway to its final destination.

### SUMMARY OF CERTAIN INVENTIVE ASPECTS

The present invention solves the above described problems by providing a system and method for selling a ticket, for an available first class seat, to a passenger seated in second class, when the carrier has gotten underway for its final destination (i.e. the carrier will not be taking on any more passengers). A primary advantage of this invention is that it creates a way for a carrier to earn increased revenue, while providing a passenger seated in second class an opportunity to have a more enjoyable travel experience.

A method of selling a ticket onboard a carrier, comprising a carrier, having at least two classes of accommodations, the at least two classes, comprising a first and second class, the first class accommodation having at least one empty seat, and offering to sell a ticket for the empty seat, to a passenger seated in the second class accommodation.

In another embodiment, a system for selling a ticket onboard a carrier, comprising means for determining the availability of a first class seat onboard a carrier, wherein the carrier is underway to its final destination, means for determining whether there is at least one passenger seated in the carrier's second class; and means for offering to sell a ticket for the available first class seat to the seated second class passenger.

In another embodiment, a method for auctioning a first class seat ticket to passengers seated in second class, comprising, a carrier on its way to a final destination, having an empty first class seat and at least two seated second class passengers and an offer to the second class passengers to buy a ticket for the empty first class seat via an onboard auction.

These and other features, aspects and embodiments of the invention will be described in more detail below.

### BRIEF DESCRIPTION OF THE DRAWINGS

FIG. 1 is a block diagram illustrating an exemplary system in accordance with certain embodiments of the present invention.

FIG. 2 is a flow diagram illustrating an exemplary method for purchasing an available first class seat by an onboard auction in accordance with certain embodiments of the present invention.

### DETAILED DESCRIPTION OF A PREFERRED EMBODIMENT

A system and method is disclosed for selling a ticket for an available first class seat to a seated second class passenger, onboard a carrier that is on its way to a final destination. While a stewardess, auctioneer, etc., may determine the availability of an empty first class seat, identify reward program members seated in second class (e.g. by a show of hands), make an offer to sell a ticket for an available first class seat, accept bids, etc., it is preferable that the invention be implemented in software; namely an onboard (electronic) sales system to sell a ticket for an empty first class seat to a seated second class passenger. When two or more persons are seated in the second class cabin, the onboard sales system preferably sells a first class seat ticket via an auction among the seated second class passengers who are members of the carrier's customer loyalty program.

The invention will be discussed in the context of a flight; however any commercial transportation provider, airline, passenger train, cruise line, etc., that offers more than one class of travel to its passengers is included. Further, while the auction will be discussed in the context of an open ascending price auction, it is contemplated to include other auction types (e.g. Vickrey auction).

Once an airplane is underway to its final destination (i.e. no additional passengers are to board), a determination is made whether a first class seat is available, and whether there is at least one seated second class passenger to buy a ticket for the available first class seat. In a preferred embodiment, this determination will be made for each flight that is not scheduled to allow additional passengers to board (e.g. a “non-stop flight”).

In an alternate embodiment, the determination will be made only when the flight is scheduled to reach a triggering event. A “triggering event” occurs when the flight's duration is scheduled to reach or exceed, a time trigger (e.g. fly five hours or more), or a distance trigger (e.g. fly 4,000 miles or more).

In a preferred embodiment, only a ticket for an empty first class seat that is located in a row of empty seats, will be offered to a second class passenger. In this way, any already seated first class passenger will not feel encroached upon by a newly seated first class passenger. In alternative embodiments (in descending order of preference) the first class empty seat will be between two (left and right) empty first class seats, between one empty first class seat (right or left) and an aisle, adjacent to at least one (left or right) empty first class seat, adjacent to an aisle, or simply be an available empty first class seat.

In a preferred embodiment, an offer to buy a ticket for an available first class seat will be made only to a qualifying second class passenger. A “qualifying” passenger is a passenger who belongs to the carrier's customer loyalty program (e.g. “frequent flyer”). In an alternative embodiment, an offer to buy a ticket for an available first class seat may be made to every seated second class passenger, via a display(s) located in the second class cabin, or by a general announcement via intercom, stewardess, etc.

In an alternate embodiment, a stewardess may hand out individual written instructions on how to buy/bid on an available first class seat, and then collect the written bids from passengers at the end of an auction period, selecting the highest bid. Selecting an auction winner is well known by those in the art and not discussed further herein.

In a preferred embodiment, any second class passenger who wins an auction to buy a first class seat ticket, will be required to pay for the ticket while onboard, before being reseated to first class.

When the offer to buy a ticket is made only to limited group of second class passengers (i.e. customer loyalty program members); it is preferable that the offer be made discreetly, by means of an individual display that is embedded in a seat, or bulkhead, immediately in front of the targeted second class seated passenger(s).

Alternatively, when a general offer to buy a ticket for an available first class seat (i.e. an offer made to all the passengers seated in the second class cabin) is made, the offer may be communicated by using a large cabin display(s) viewable by all seated second class passengers (e.g. via a display, or screen that is used to show movies during a flight), or by individual displays located in front of each second class passenger. In either an offer made to a limited group of second class passengers, or a general offer made to every passenger seated in second class, second class passengers may interactively place bids via a touch keypad provided by the carrier (e.g. soft key, touch screen display, etc.).

In a preferred embodiment, the timing of the offer is immediately following a passenger safety demonstration. Passenger safety demonstrations typically occur before a plane has taken off. Alternatively, the offer may be made at any time the second class passengers are most likely to be seated in their assigned seats (e.g. when they have been instructed to remain seated via a “fasten your seatbelt” sign (or similar sign), to increase the likelihood that the offer reaches the right passenger(s), especially if the offer is made to a limited group.

In a further alternate embodiment, an offer may be made to a seated second class passenger more than once. For example, the offer may be made after the safety demonstration and again half-way through a flight, when an unhappy passenger may not be able to “take it anymore”, via an “arrive in style” campaign. In yet an another alternate embodiment, the offer may be made, or the ticket paid for, at a time the carrier moves into a geographic region (e.g. the airspace of a country) where the situs of a sale (i.e. of a ticket) results in a tax advantage to the carrier, namely a non taxable or lower tax event (e.g. “lower” than having sold the same ticket to a passenger at the point of departure). For example, an auction may be offered at the beginning of a flight, but the winning passenger actually pays for the ticket when the carrier has landed in a different country.

When only one seat exists and there is only one second class passenger, the available first class seat may be offered at a fixed price.

In a preferred embodiment, when there is at least one empty first class seat, and there are two or more second class passengers, the ticket for the available first class seat will be sold by auction.

In a preferred embodiment, the auction will have a reserve bid. The reserve bid may be equal to, or greater than a price difference between a first and second class seat. For example, the price difference may be the difference between the highest price paid for a first class seat and the highest price paid for a second class seat, the difference between the highest price paid for a first class seat and the average price paid for a second class seat, the difference between the highest price paid for a first class seat and the median price paid for a second class seat, the difference between the highest price paid for a first class seat and the lowest price paid for a second class seat, the difference between the lowest price paid for a first class seat and the highest price paid for a second class seat, the difference between the lowest price paid for a first class seat and the average price paid for a second class seat, the difference between the lowest price paid for a first class seat and the median price paid for a second class seat, the difference between the lowest price paid for a first class seat and the lowest price paid for a second class seat, the difference between the average price paid for a first class seat and the highest price paid for a second class seat, the difference between the average price paid for a first class seat and the average price paid for a second class seat, the difference between the average price paid for a first class seat and the median price paid for a second class seat, the difference between the average price paid for a first class seat and the lowest price paid for a second class seat, the difference between the median price paid for a first class seat and the highest price paid for a second class seat, the difference between the median price paid for a first class seat and the average price paid for a second class seat, the difference between the median price paid for a first class seat and the median price paid for a second class seat, and the difference between the median price paid for a first class seat and the lowest price paid for a second class seat. By employing a reserve bid, the airline will insure that an already seated first class passenger will not feel slighted for the price he/she paid for his/her seat.

In an alternative embodiment, reserve bid may be inversely correlated to the distance traveled by the carrier, so that a reserve bid will decrease in price, the more miles/minutes the carrier travels during its trip.

In alternate embodiment, the auction will have not had a reserve bid.

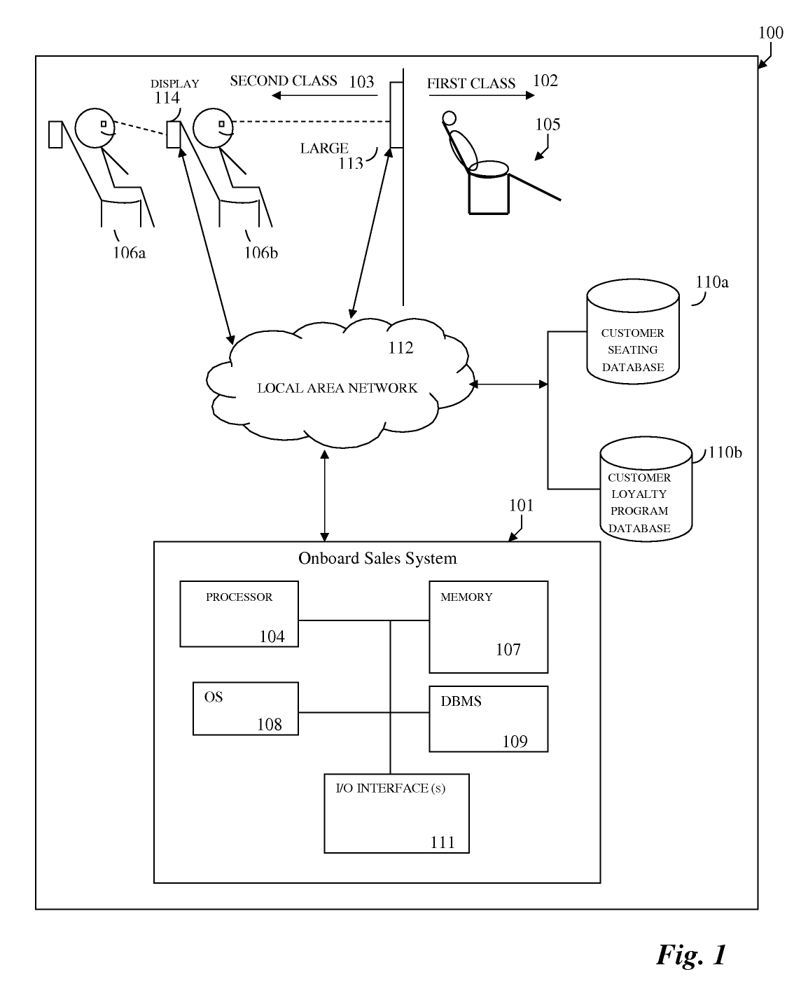

Exemplary embodiments of the present invention will hereinafter be described with references to the figures, in which like numerals indicate elements throughout the several drawings. FIG. 1 is a block diagram illustrating an exemplary operating environment for implementation of certain embodiments of the present invention in selling by auction an available first class ticket to a seated second class passenger.

The exemplary operating environment includes a carrier 100, on its way to a final destination (i.e. is not scheduled to take on any additional passengers). The carrier 100 has an Onboard Sales System (OSS) 101, at least two classes of passenger accommodations, namely a first class cabin 102 and a second class cabin 103.

The OSS 101 is contemplated as being a processor 104 driven device, or collection of devices, that is configured to determine the availability of an empty first class seat 105, the availability of qualifying buyers (i.e. at least two seated second class passengers 106a and 106b who are members of the carrier's 100 customer loyalty program), and conducting an auction of the available first class seat 105.

The OSS 101 has a processor 104 and a memory 107 for storing data. The memory 107 is coupled to the processor 104. The OSS 101 may further be configured for accessing and reading associated computer readable media stored thereon, data and/or computer executable instructions for implementing the various methods of the present invention. In particular, the processor 104 provides the business logic for the OSS 101 that supports and provides an environment for server side logic, expressed as objects, rules and computations, such as determining a winning bid when more than one seated second class passenger 106a and 106b submits a bid that exceeds a reserve bid (when the sale of ticket for the available first class seat 105 is done by auction having a reserve bid).

The memory 107 may take the form of any computer readable medium. The memory 107 may be logically and or physically divided into multiple units. The memory 107 stores data and program modules, for example an operating system (OS) 108, a database management system (DBMS) 109. These and/or other programs may be executed by the OSS 101 to perform the various methods of the present invention

The OSS 101 may include, or be in communication with, one or more searchable databases. By way of illustration only, the OSS 101 may be in communication with a Customer Seating Database 110a and a Customer Loyalty Program Database 110b. These and/or other databases may also store any other data used or generated by the OSS 101. Those skilled in the art will appreciate that the illustrated database may be physically and/or logically separate from one another.

The OSS 101 may also include input/output (I/O) interfaces 111 for providing logical connections to various I/O devices, such as a keyboard, keypad, etc. A system administrator (e.g. stewardess) may utilize these and other I/O devices to interact with the OSS 101. For example, a system administrator may interact with the OSS 101 to populate and edit the Customer Seating Database 110a, and other modules and program modules. Those skilled in the art will appreciate that the OSS 101 may include alternate, and/or additional components, hardware or software.

Thus configured or similarly configured, the OSS 101 may provide a means for seated second class passengers 106a and 106b to participate in an auction to buy a ticket for an available first class seat 105.

The OSS 101 may access the databases 110a-110b, and communicate an offer to the seated second class passengers 106a and 106b via a local area network (LAN) 112. The LAN 112 may be composed of wired or wireless segments. The OSS 101 communicates to the passengers 106a and 106b via displays 113 and 114 that are connected to the OSS 101 by the LAN 112. The offer to participate may be communicated via a large display 113 that is easily viewed by a number of second class passengers, or via a smaller display 114 that may be embedded in the back of another second class passenger's seat located immediately in front of a targeted second class passenger. For example, when the sale is only made to members of the Carrier's 100 Customer Loyalty Program.

Passengers who participate in a auction for the purchase of a ticket for an available first class seat 105 may communicate their respective bids to the OSS 101 by entering bids via a keypad integrated with a display 114 (e.g. soft keys, touch screen), or via hard keys (not shown) built into seat armrests (not shown). In an alternate embodiment, passengers 106a and 106b may submit bids on a filled out forms that have been provided by the carrier's 100 stewardess(es). Auctions, submitting bids, making known/concealing competing bids, closing an auction, choosing a winning bid, notifying participants of the outcome, and settlement are well known to those skilled in the art and are not discussed further herein.

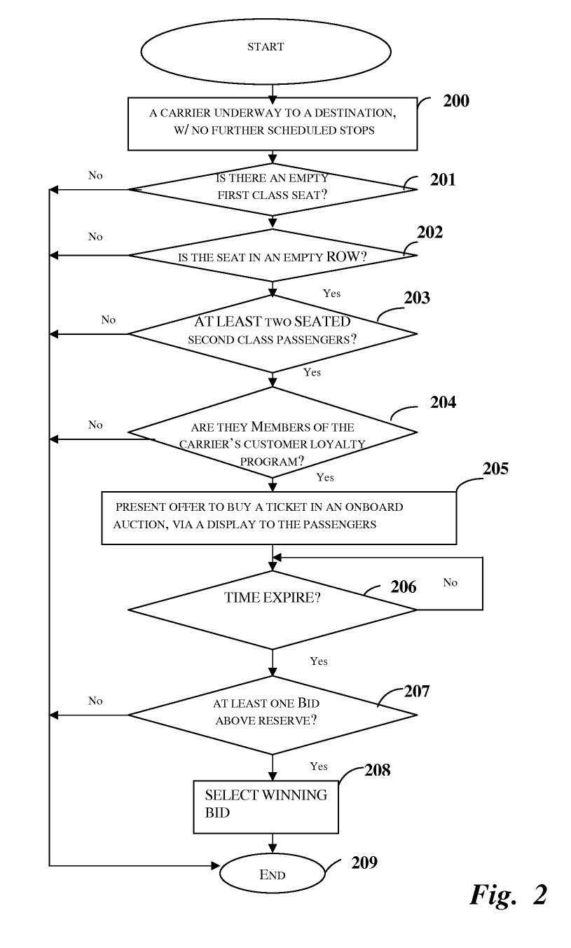

FIG. 2 is a flowchart, illustrating in further detail one method of employing the OSS 101 such as that of FIG. 1, to make a sale of ticket for an available first class seat 105 to a seated second class passenger 106a or 106b via an onboard auction.

At step 200, a carrier 100 is underway to a destination, with no further scheduled stops (i.e. no additional passengers will be boarding for the duration of the trip). A carrier includes an airplane, train and a ship, and other modes of passenger transportation that have at least two classes of passenger accommodations (e.g. a bus) and receive payment for providing passenger transportation.

The method proceeds to step 201 where the OSS 101 queries the customer seating database 110a and determines whether there is at least one available first class seat 105 in the first class cabin 102. In a preferred embodiment this determination will be done for each flight when no additional passengers are scheduled to board. However, in an alternate embodiment, this method may be employed only when the duration of the travel is equal to, or greater than, a triggering event selected by a carrier. A “triggering event” may include a threshold distance (e.g. 4,000 miles) or a threshold time (e.g. flight time less than five hours). For example, a carrier 100 may decide that it would not be cost effective, or too disruptive to conduct an auction for less than a selected trigger event (e.g. a five hour time trigger).

If there is no available first class seat 105, the method proceeds to step 209 and ends.

When there is at least one available first class seat 105, the method proceeds to step 202. At step 202, in a preferred embodiment, the OSS 101 determines whether the first class seat 105 is located in an empty row of first class seats by querying the customer seating database 110a. In this way a second class passenger (example 106a) who successfully bids on the empty first class seat 105 will not encroach upon the space of an already seated first class passenger (not shown). If the first class seat 105 is not located in a row of empty first class seats, the method proceeds to step 209 and ends.

In alternate embodiment the customer seating database 110a may be queried to determine if the available first class seat 105 is between two (left and right side) empty first class seats, between an empty first class seat and an aisle, adjacent (left or right) to an available first class seat 105, or simply an available empty first class seat 105, notwithstanding whether or not there is any other empty/adjacent first class seat/aisle to proceed to the next step.

When the empty first class seat 105 is located in a row of empty first class seats, the method proceeds to step 203, where the OSS 101 queries the customer seating database 110a to determine whether there are at least two seated second class passengers 106a and 106b. If there are not at least two seated second class passengers 106a and 106b the method proceeds to step 209 and ends.

Upon determining that there are at least two seated second class passengers 106a and 106b, the method proceeds to step 204 where the OSS 101 queries the Customer Loyalty Program Database 110b to determine whether the second class passengers 106a and 106b are participants in the carrier's 100 Customer Loyalty Program. In a preferred embodiment, when there are not at least two seated second class passengers 106a and 106b who are also participants in the carrier's 100 Customer Loyalty Program, the method proceeds to step 209 and ends.

In an alternate embodiment, an auction for the ticket may be had when there are at least two seated second class passengers 106a and 106b, the method will proceed to step 205, notwithstanding passengers participation in the carrier's 100 Customer Loyalty Program, if any. In yet another alternate embodiment, when there is one seated second class passenger (example 106a) who is also a participant in the carrier's 100 Customer Loyalty Program, the passenger may be offered to buy a ticket for the available first class seat 105 for a fixed price. In still yet another alternate embodiment, any seated second class passenger, notwithstanding his/her participation in the carrier's 100 Customer Loyalty Program, may be offered an opportunity to purchase, at a fixed price or auction (when there are two or more seated second class passengers), a ticket for an available first class seat 105.

The preferred embodiment of only offering a ticket for sale to members of the carrier's 100 Customer Loyalty Program provides an incentive for passengers to join the carrier's 100 program. Thus, the carrier may use the proposed auction as a marketing tool to enroll passengers in the carrier's 100 Customer Loyalty Program.

When the OSS 101 determines that the two seated second class passengers 106a and 106b are also members of the carrier's 100 Customer Loyalty Program, the method proceeds to step 205 where the passengers 106a and 106b are offered to buy a ticket for the available first class seat 105 via an onboard auction. This may be accomplished when the passengers 106a and 106b are seated in their assigned seats via a small display 114 located immediately in front of the target passengers 106a and 106b. For example, the offer may be made immediately following a safety demonstration, or when a “fasten your seatbelt”, or similar light is on, to increase the probability that the message reaches the targeted passengers 106a and 106b.

In an alternate embodiment, when all seated second class passengers may participate in the purchase of a ticket for an available first class seat 105the offer may be communicated via a large display 113, or collection of displays, that are located in a position (e.g. high on a bulkhead) that the entire second class cabin may see. In a further alternate embodiment, a stewardess may simply provide a bid form to second class passengers with instructions on how to participate in an auction.

In a preferred embodiment, the offer will contain a minimum reserve bid (supra), payment terms (e.g. pay before being reseated in first class). In this way, seated first class passengers will feel that they have been treated fairly by the carrier 100, and not taken advantage of, by buying a first class ticket before boarding the carrier 100. The reserve bid may be inversely correlated to either the distance traveled by the carrier 100, or the elapsed time of the trip, or both. For example, the reserve bid may be reduced $15.00 for every 10 miles traveled, or 30 minutes of airtime.

In a preferred embodiment, the offer to buy a first class ticket for an available first class seat 105 will be made once during the trip.

In an alternate embodiment, the offer may be made more than once (e.g. at the beginning of the trip, and again half-way through the trip under an “arrive in style campaign”). In another alternate embodiment, the carrier 100 may make the offer available when the carrier 100 has crossed into a jurisdiction (geographic region) that gives the carrier 100 a tax advantage (e.g. no-tax, reduced tax) to make a sale in that jurisdiction (e.g. the landing situs).

Once the offer is made, the method proceeds to step 206, where it is determined if the time of the auction has expired. If time remains, the method continues to check, at repeating regular intervals, whether the time is up. When the time has expired, the method proceeds to step 207 where passengers are informed that the auction has closed, and it is determined whether there is at least one bid at or above the reserve bid price. If there has been no bid at, or above the reserve, the method proceeds to step 209 and ends.

When at least one bid has been received that meets or exceeds the reserve, the method proceeds to step 208, where the winning (i.e. highest) bid is selected. Selecting a winning bid, tie-breaking, and fixing the price to be paid by the winner (e.g. selecting the highest bid received, but choosing price to pay based on the second highest bid and adding a small percentage to it, etc.) may be accomplished by auction methods known in the art. In an alternate embodiment, the auction may have no reserve, and the highest bid may be selected.

Once the winning bid is selected, the participants are notified of the result, the winner pays for the ticket and is reseated in the available first class seat 105. The method proceeds to step 209 and ends.

The disclosed invention creates a new source of revenue for carriers, and gives passengers in second class an opportunity to enhance their travel experience by traveling in first class accommodations. Further, a carrier may increase the membership of a carrier customer loyalty program by only allowing members to participate in any onboard auction.

It should be appreciated that the exemplary aspects and features of the present invention as described above are not intended to be interpreted as required or essential elements of the invention, unless explicitly stated as such. It should also be appreciated that the foregoing description of exemplary embodiments was provided by way of illustration only and that many other modifications, features, embodiments, and operating environments are possible. Accordingly, the scope of the present invention should be limited only by the claims that follow.

I claim:

1. A method of selling a ticket onboard a carrier, comprising:
a carrier, having at least two classes of accommodations;
the at least two classes, comprising a first class and second class;
the first class accommodation having at least one empty seat; and
offering to sell a ticket for the empty first class seat to a seated second class passenger.

2. The method of claim 1, wherein the carrier is one of a group, comprising a plane, a train, and a ship.

3. The method of claim 1, wherein the carrier will not be taking on additional passengers for the duration of its trip.

4. The method of claim 1, wherein the empty first class seat is one of a group, comprising a seat, a room, and a cabin.

5. The method of claim 1, wherein the empty first class seat is located in an empty row of first class seats.

6. The method of claim 1, wherein the empty first class seat is adjacent to at least one other empty first class seat.

7. The method of claim 1, wherein the offer is made to the second class passenger while a fasten your seatbelt sign is on.

8. The method of claim 1, wherein the offer is made when the scheduled travel is equal to, or greater than, a triggering event, the triggering event consists of a group, comprising a duration trigger and a distance trigger.

9. The method of claim 1, wherein the offer is communicated to a seated second class passenger that is a member of the carrier's customer loyalty program.

10. The method of claim 1, wherein the offer is communicated via a display that is embedded in a seat immediately in front of the second class passenger.

11. The method of claim 1, wherein the price of the empty first class seat is a fixed price.

12. The method of claim 1, wherein the price of the empty first class seat is established by auction, when there are at least tow seated second class passengers.

13. The method of claim 12, wherein the auction has no reserve bid.

14. The method of claim 12, wherein the auction has a reserve bid.

15. The method of claim 14, wherein the reserve bid is inversely correlated to the distance traveled by the carrier.

16. The method of claim 14, wherein the reserve bid is equal to, or greater than a difference, the difference is one of a group, comprising:
the difference between the highest price paid for a first class seat and the highest price paid for a second class seat;
the difference between the highest price paid for a first class seat and the average price paid for a second class seat;
the difference between the highest price paid for a first class seat and the median price paid for a second class seat;
the difference between the highest price paid for a first class seat and the lowest price paid for a second class seat;
the difference between the lowest price paid for a first class seat and the highest price paid for a second class seat;
the difference between the lowest price paid for a first class seat and the average price paid for a second class seat;
the difference between the lowest price paid for a first class seat and the median price paid for a second class seat;
the difference between the lowest price paid for a first class seat and the lowest price paid for a second class seat;
the difference between the average price paid for a first class seat and the highest price paid for a second class seat;
the difference between the average price paid for a first class seat and the average price paid for a second class seat;
the difference between the average price paid for a first class seat and the median price paid for a second class seat;
the difference between the average price paid for a first class seat and the lowest price paid for a second class seat;
the difference between the median price paid for a first class seat and the highest price paid for a second class seat;
the difference between the median price paid for a first class seat and the average price paid for a second class seat;
the difference between the median price paid for a first class seat and the median price paid for a second class seat; and
the difference between the median price paid for a first class seat and the lowest price paid for a second class seat.

17. A computer-readable medium having stored thereon computer executable instructions for performing the method of claim 1.

18. A system for selling a first class ticket onboard a carrier, comprising:
means for determining the availability of a first class seat onboard a carrier, wherein the carrier is underway to its final destination;
means for determining whether there is at least one passenger seated in the carrier's second class; and
means for offering to sell a ticket for the available first class seat to the seated second class passenger.

19. The system of claim 18, wherein the means to establish the price of the ticket is an auction, when there are at least two seated second class passengers.

20. A method for auctioning a first class seat ticket to passengers seated in a carrier's second class, comprising:
a carrier on its way to a final destination;
the carrier having an empty first class seat;
the carrier having at least two seated second class passengers; and
making an offer to the second class passengers to buy a ticket for the empty first class seat via an onboard auction.

21. The method of claim 20, wherein the offer is made when the scheduled travel is equal to, or greater than, a triggering event, the triggering event consists of a group, comprising a duration trigger and a distance trigger.

22. The system of claim 20, wherein the offer is made while a fasten your seatbelt sign is on.

23. The method of claim 20, wherein the situs of the ticket sale results in a tax advantage to the carrier, compared to the carrier's point of departure.

24. The method of claim 20, where the auction is used as a marketing tool, to enroll passengers in the carrier's customer loyalty program.
